(19) United States
(12) Patent Application Publication
(10) Pub. No.: US 2024/0405476 A1
(43) Pub. Date: Dec. 5, 2024

(54) RF CONNECTOR HAVING SHIELDING STRUCTURE

(71) Applicant: NOVATECH CO., LTD., Gyeonggi-do (KR)

(72) Inventors: KONHEE CHANG, Gyeonggi-do (KR); JONGHYUN CHAE, Gyeonggi-do (KR)

(21) Appl. No.: 18/700,388

(22) PCT Filed: Oct. 13, 2022
(86) PCT No.: PCT/KR2022/015531

§ 371 Date: Apr. 11, 2024

(30) Foreign Application Priority Data
Oct. 13, 2021 (KR) 10-2021-0135597

(51) Int. Cl. H01R 13/62; H01R 13/6581; H01R 13/6598

(52) U.S. Cl. CPC H01R 13/6205; H01R 13/6581; H01R 13/6598

(57) ABSTRACT

An RF connector has a shielding structure that may be easily attached and detached and has a shielding function that may be implemented to have an appropriate coupling force depending on the type or use of the communication facility and equipment to which the RF connector having a shielding structure is to be mounted.

### CROSS REFERENCE TO RELATED APPLICATIONS AND CLAIM OF PRIORITY

This application claims benefit under 35 U.S.C. 119, 120, 121, or 365 (c), and is a National Stage entry from International Application No. PCT/KR2022/015531 filed on Oct. 13, 2022, which claims priority to the benefit of Korean Patent Application No. 10-2021-0135597 filed on Oct. 13, 2021, in the Korean Intellectual Property Office, the entire contents of which are incorporated herein by reference.

### BACKGROUND

### 1. Technical Field

The present invention relates to an RF connector having a shielding structure, and particularly, to an RF connector having a shielding structure which may be implemented to have a coupling force that meets a purpose depending on the type or use of communication facility and equipment on which the RF connector is to be mounted, and has a shielding function while allowing for easy attachment and detachment thereof.

### 2. Background Art

In general, as a communication network which enables users using a portable communication device to communicate with each other, wired and wireless communication such as wireless communication between a base station and repeaters and wired communication within the communication device are utilized. In the case of the wired communication, radio frequency (RF) cables are widely used to connect each communication equipment.

In addition, various communication cables such as telephone lines, high-speed Internet lines, and CATV/MATV cables other than electric cables are constructed in the apartments and buildings.

Due to the recent development of home automation technologies, the number of cases where the control and communication of many different home appliances through various communication cables is increasing. Thereby, as construction of the communication cables is increased, a structure capable of economically reducing costs while also allowing for easy future inspection or replacement is required.

In addition, as wireless communication devices become increasingly slimmer with miniaturization and higher performance, RF connectors having a shielding structure along with multiple components are installed in the limited PCB space.

Since the RF connectors having such a shielding structure may cause reflection and distortion in signals, it is important to shield the connection portion to prevent the signals from interfering with each other.

Further, in an environment such as war, when soldiers who use communication equipment replace and change the communication equipment in an urgent situation, a structure that allows the soldiers to easily and quickly attach and detach the RF connector having a shielding structure will be required.

### SUMMARY

In consideration of the above-mentioned circumstances, it is an object of the present invention to provide an RF connector having a shielding structure which may be implemented to have an appropriate coupling force depending on the type or use of communication equipment on which the RF connector is to be mounted, and has a shielding function while allowing for easy attachment and detachment thereof.

To achieve the above object, according to an aspect of the present invention, there is provided an RF connector having a shielding structure including: a first connector which comprises a magnet of a first structure (“first structural magnet”) at a portion of an end thereof; a second connector which comprises a magnet of a second structure (“second structural magnet”) at a portion of an end thereof, wherein a polarity of a portion facing the first structural magnet is opposite to each other, and the end is provided to be detachably attached to the end of the first connector by a magnetic force generated between the first structural magnet and the second structural magnet; and a shielding structure provided on at least one surface other than a surface where the first structural magnet and the second structural magnet are attached to each other.

The RF connector according to the embodiment of the present invention as described above may employ magnets as an attaching and detaching member, thus to easily and quickly respond to replacement or change of the communication equipment.

In addition, the RF connector having a shielding structure according to an embodiment of the present invention may employ a structure with an enhanced shielding function.

Further, according to the present invention, a designer of the RF connector having a shielding structure may determine the number of magnets or the degree of cover of the shielding structure that covers the magnets depending on the type or use of the communication equipment on which the RF connector having a shielding structure is to be mounted, thereby it is possible to implement a coupling force of the RF connector having a shielding structure that meets the purpose.

### BRIEF DESCRIPTION OF THE DRAWINGS

FIG. 1 is a perspective view of an RF connector having a shielding structure according to a first embodiment of the present invention.

FIG. 2 is a perspective view of an RF connector having a shielding structure according to a second embodiment of the present invention.

FIG. 3 is a perspective view of an RF connector having a shielding structure according to a third embodiment of the present invention.

FIG. 4 is a longitudinal sectional view of the RF connector having a shielding structure according to the third embodiment of the present invention in the coupled state.

FIG. 5 is a cross-sectional view of the RF connector having a shielding structure according to the third embodiment of the present invention in the coupled state.

FIG. 6 is a longitudinal sectional view of the first connector equipped with the shielding structure of the present invention.

FIG. 7 is a perspective view of an RF connector having a shielding structure according to a fourth embodiment of the present invention.

FIG. 8 is a longitudinal sectional view of the RF connector having a shielding structure according to the fourth embodiment of the present invention in the coupled state.

FIG. 9 is a longitudinal sectional view and a cross-sectional view of a first connector equipped with the shielding structure of the present invention.

FIG. 10 is a cross-sectional view showing an example of the first connector.

FIG. 11 is a view showing an example of a shielding structure according to an embodiment of the present invention.

FIGS. 12 to 15 are longitudinal sectional views showing examples of the RF connector having a shielding structure according to various embodiments of the present invention in a state where the shielding structure is mounted.

FIG. 16 shows an example of utilization of the RF connector having a shielding structure according to embodiments of the present invention.

### DETAILED DESCRIPTION

Hereinafter, embodiments according to the present invention will be described in detail with reference to the accompanying drawings. In denoting reference numerals to components of respective drawings, it should be noted that the same components will be denoted by the same reference numerals although they are illustrated in different drawings. Further, in description of embodiments of the present invention, the publicly known functions and configurations related to the present invention, which are determined to be able to make the purport of the present invention unnecessarily obscure will not be described in detail. In addition, embodiments of the present invention will be described below, but the technical idea of the present invention is not limited or limited thereto and may be modified and implemented in various ways by those skilled in the art.

Throughout this specification, when it is described that a portion is “connected” to another portion, the portion may be “directly connected” to the other portion or “indirectly connected” with the other element interposed therebetween. In addition, when it is described that a portion “comprises or includes” a component, this means that the part may further r include other components without excluding the other components, unless there is a description opposite thereto.

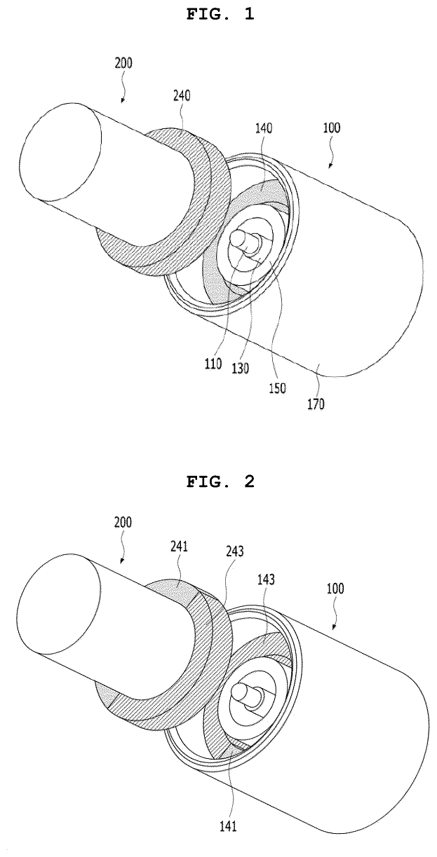

FIG. 1 is a perspective view of an RF connector according to a first embodiment of the present invention.

Referring to FIG. 1, the RF connector according to the first embodiment includes a first connector 100 and a second connector 200.

Here, the first connector 100 and the second connector 200 refer to connectors which serve to connect an RF cable with another RF cable, or connect the RF cables with an adapter.

The first connector 100 includes a magnet of a first structure (“first structural magnet”) 140 at a portion of an end thereof.

The second connector 200 includes a magnet of a second structure (“second structural magnet”) 240 corresponding to the first structure at a portion of an end thereof. That is, the second connector 200 includes the second structural magnet 240 in which a polarity of a portion facing the first structural magnet 140 is opposite to each other.

Based on the magnetic force generated between the polarity by the first structural magnet 140 and the polarity by the second structural magnet 240, a structure, in which the end of the first connector 100 and the end of the second connector are detachably attached to each other, is achieved.

The first connector 100 may include a first signal conductor 110 disposed to penetrate a cross section of the end in a longitudinal direction of the first connector 100, an insulation part 130 disposed to surround the first signal conductor 110, the first structural magnet 140 provided along a portion of the insulation part 130, and a housing 170 which covers the first connector 100.

The second connector 200 includes a second signal conductor 210 disposed to penetrate a cross section of the end in a longitudinal direction of the second connector 200, an insulation part 230 disposed to surround the second signal conductor 210, and the second structural magnet 240 provided along a portion of the insulation part 230.

Specifically, in the RF connector according to the first embodiment, the entire first structural magnet 140 may be provided as a magnet of a first polarity, and the entire second structural magnet 240 may be provided as a magnet of a second polarity which is a polarity opposite to the first polarity. That is, the first structure of the first connector 100 according to the first embodiment may be provided as, for example, an S-pole magnet over the entire cross section thereof, and the second structure of the second connector 200 may be provided as an N-pole magnet over the entire cross section thereof.

Due to the above-described structure, attraction is generated between the first structural magnet 140 and the second structural magnet 240 to cause the first connector 100 and the second connector 200 to be attached, such that the first signal conductor 110 and the second signal conductor 210 come into close contact with each other to be electrically contacted.

In one embodiment, the second structural magnet 240 may be inserted into a hole of the first structural magnet 140 formed in a donut shape, and the first connector 100 and the second connector 200 may be coupled and attached.

While the first structural magnet 140 and the second structural magnet 240 are attached by the attraction, if an external force that pulls objects in different directions is applied to the first connector 100 and the second connector 200, the first structural magnet 140 and the second structural magnet 240 may be separated. Accordingly, the electrical connection between the first signal conductor 110 and the second signal conductor 210 may be disconnected.

In one embodiment of the present invention, sizes of the first structural magnet 140 and the second structural magnet 240 are not particularly limited, but the direction and spatial arrangement of magnetization are designed to maximize the magnetic force.

As materials of the first structural magnet 140 and the second structural magnet 240, for example, ferrite-based, alnico-based, rare earth-based, or bond-based magnet materials may be used. In addition thereto, the materials are not particularly limited as long as they are magnet material commonly used in the art.

The number of the poles of the first structural magnet 140 and the second structural magnet 240 is not particularly limited, but is preferably 1 pole or more, 2 poles or more, 4 poles or more or 6 poles or more, and 16 poles or less, 12 poles or less, 10 poles or less or 8 poles or less.

In general, as the number of the poles is increased, the magnetic force is increased. However, if the number of the poles is too large, a problem, in which magnetic field direction of the first structural magnet is not transmitted to the second structural magnet, may occur. In addition, (according to an experimental example described below), it can be seen that, as the number of the poles is increased, the increase rate in the magnetic force is gradually decreased.

FIG. 2 is a perspective view of an RF connector according to a second embodiment of the present invention.

Only a first structural magnet 140 and a second structural magnet 240 of the RF connector of the second embodiment are different from those of the first embodiment described above with reference to FIG. 1, and the remaining configurations are the same as the first embodiment in terms of structures and roles thereof, therefore the same portions will not be described in detail while referring to the above-described contents.

Referring to FIG. 2, the structure of the first connector 100 of the second embodiment may include a first polar magnet 141 and a second polar magnet 143 having a polarity opposite to the first polarity, which are provided laterally adjacent to each other based on the cross section. That is, the first polar magnet 141 and the second polar magnet 143 may be provided laterally adjacent to each other in a first direction.

Here, the first direction may refer to an X-axis, a second direction may refer to a Y-axis, and a third direction may refer to a Z-axis.

The structure of the second connector 200 may include a first polar magnet 241 and a second polar magnet 243 having a polarity opposite to the first polarity, which are provided laterally adjacent to each other based on the cross section. That is, the first polar magnet 241 and the second polar magnet 243 may be provided laterally adjacent to each other in the first direction.

Here, if the first polarity is an N pole, the second polarity may be an S pole, and conversely, if the first polarity is the S pole, the second polarity may be the N pole.

Due to the above-described structure, when the portions where the first structural magnet 140 and the second structural magnet 240 face each other correspond to each other as magnets having different polarities, attraction is generated between the first structural magnet 140 and the second structural magnet 240 to cause the first connector 100 and the second connector 200 to be attached, such that the first signal conductor 110 and the second signal conductor 210 may come into close contact with each other to be electrically contacted.

In one embodiment, the second structural magnet 240 may be inserted into a hole of the first structural magnet 140 formed in a donut shape, and the first connector 100 and the second connector 200 may be coupled and attached.

While the first connector 100 and the second connector 200 are attached, if an external force that twists the first connector 100 and the second connector 200 at a predetermined angle is generated from an outside, the portions where the first structural magnet 140 and the second structural magnet 240 face each other may be changed.

That is, the portions where the first structural magnet 140 and the second structural magnet 240 face each other may correspond to each other as magnets having the same polarity due to the external force that twists at least one of the first connector 100 and the second connector 200. Thereby, repulsion is generated between the first structural magnet 140 and the second structural magnet 240, such that the first connector 100 and the second connector 200 may be easily separated by the force pushing each other.

Accordingly, the electrical connection between the first signal conductor 110 and the second signal conductor 210 may be disconnected.

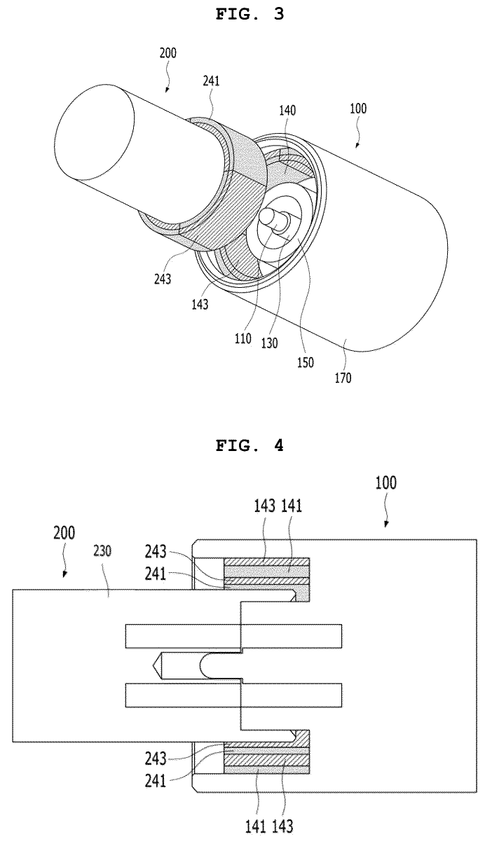

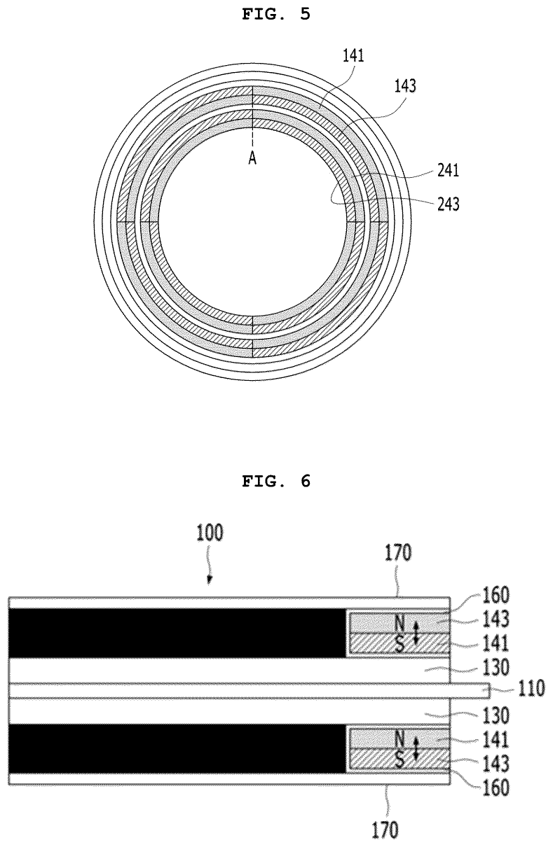

FIG. 3 is a perspective view of an RF connector according to a third embodiment of the present invention, FIG. 4 is a longitudinal sectional view of the RF connector according to the third embodiment of the present invention in the coupled state, FIG. 5 is a cross-sectional view of the RF connector according to the third embodiment of the present invention in the coupled state, and FIG. 6 is a longitudinal sectional view of the first connector equipped with the shielding structure of the present invention.

Only a first structural magnet 140 and a second structural magnet 240 of the RF connector of the third embodiment are similarly different from those of the first embodiment described above with reference to FIG. 1, and the remaining configurations are the same as the first embodiment in terms of structures and roles thereof, therefore the same portions will not be described in detail while referring to the above-described contents.

Referring to FIG. 3, the first connector 100 of the third embodiment may include: a plurality of first polar magnets 141 and a plurality of second polar magnets 143, which are alternately arranged to be laterally adjacent to each other in the first direction based on the cross section of the first structural magnet 140; and at least one first polar magnet 141 and at least one second polar magnet 143, which are provided to be also laterally attached in the second direction to form a multi-pole magnet.

The second structural magnet 240 of the second connector 200 may include: a plurality of first polar magnets 241 and a plurality of second polar magnets 243, which are alternately arranged to be laterally adjacent to each other in the first direction based on the cross section; and at least one first polar magnet 241 and at least one second polar magnet 243, which are provided to be also laterally attached in the second direction to form a multi-pole magnet.

Here, if the first polarity is an N pole, the second polarity may be an S pole, and conversely, if the first polarity is the S pole, the second polarity may be the N pole.

In the embodiment illustrated in FIG. 3, the case, in which four first polar magnets and four second polar magnets per connector are employed, has been described as an example, but the number of the magnets may not be limited thereto.

Referring to FIGS. 4 and 5, due to the above-described structure, when the portions where the first structural magnet 140 and the second structural magnet 240 face each other correspond to each other as magnets having different polarities, attraction is generated between the first structural magnet 140 and the second structural magnet 240 to cause the first connector 100 and the second connector 200 to be attached, such that the first signal conductor 110 and the second signal conductor 210 may be electrically contacted.

In one embodiment, the second structural magnet 240 may be inserted into a hole of the first structural magnet 140 formed in a donut shape, and the first connector 100 and the second connector 200 may be coupled and attached.

While the first connector 100 and the second connector 200 are attached, if an external force that twists the first connector 100 and the second connector 200 at a predetermined angle is generated from an outside, the portions where the first structural magnet 140 and the second structural magnet 240 face each other may be changed.

That is, the portions where the first structural magnet 140 and the second structural magnet 240 face each other may correspond to each other as magnets having the same polarity due to the external force that twists at least one of the first connector 100 and the second connector 200. Thereby, repulsion is generated between the first structural magnet 140 and the second structural magnet 240, such that the first connector 100 and the second connector 200 may be easily separated by the force pushing each other.

Accordingly, the electrical connection between the first signal conductor 110 and the second signal conductor 210 may be disconnected.

In the mechanical magnetic RF connector according to embodiments of the present invention, a force with which the first connector 100 and the second connector 200 are magnetically coupled may vary depending on the number of the poles.

For example, the mechanical magnetic RF connector in the coupled state shown in FIG. 5 is the case of having 8 poles based on a cross section taken on line A in the second direction, and compared to the case of having 4 poles and the case of having a single pole under the same condition, when experimentally measuring the attraction generated between the first connector 100 and the second connector 200, it can be seen that the force with which the first connector 100 and the second connector 200 are magnetically coupled is increased as the number of the poles is increased.

According to the above-described embodiment of the present invention, a designer of the RF connector may adjust the number of magnets depending on the type or use of the communication equipment on which the RF connector having a shielding structure is to be mounted, such that it is easy to attach and detach the RF connector, as well as it is possible to implement an RF connector with an appropriate coupling force depending on the purpose.

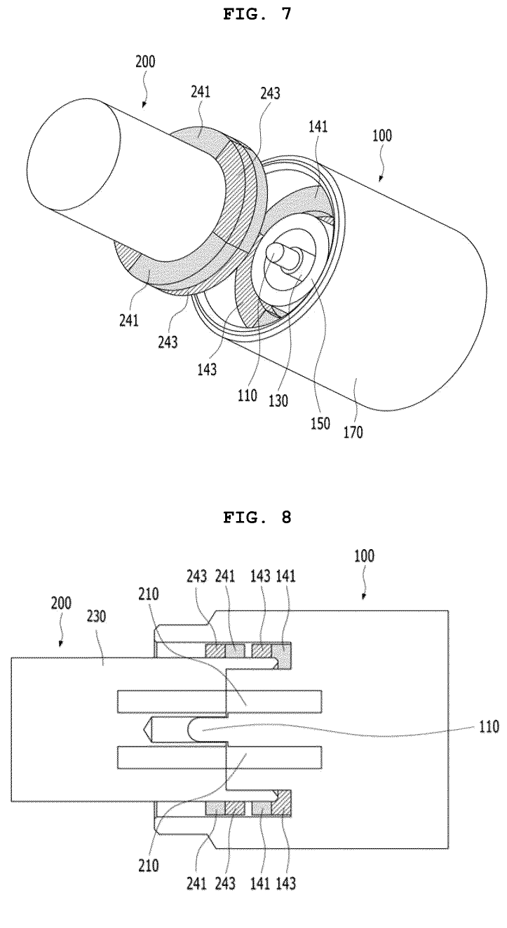

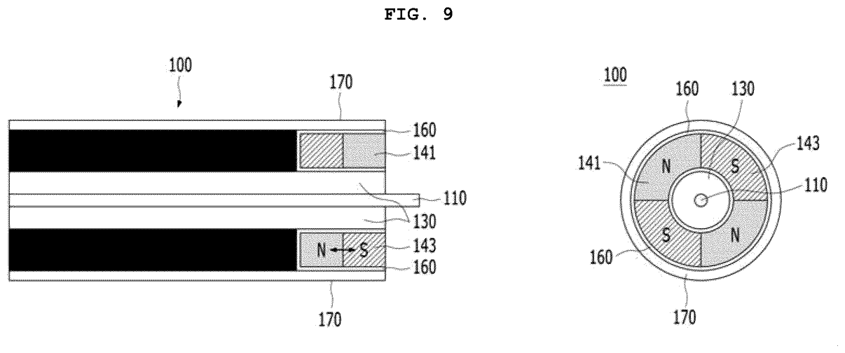

FIG. 7 is a perspective view of an RF connector according to a fourth embodiment of the present invention, FIG. 8 is a longitudinal sectional view of the RF connector according to the fourth embodiment of the present invention in the coupled state, and FIG. 9 is a longitudinal sectional view and a cross-sectional view of the RF connector having a shielding structure according to the fourth embodiment of the present invention in the coupled state.

Only a first structural magnet 140 and a second structural magnet 240 of the RF connector of the fourth embodiment are different compared to the first embodiment, and the remaining configurations are the same as the first embodiment in terms of structures and roles thereof, therefore the same portions will not be described in detail while referring to the above-described contents.

Referring to FIG. 7, the first connector 100 of the fourth embodiment may include a plurality of first polar magnets 141 and a plurality of second polar magnets 143, which are alternately arranged to be laterally adjacent to each other in the first direction based on the cross section of the first structural magnet 140; and at least one first polar magnet 141 and at least one second polar magnet 143, which are provided to be also laterally attached in the third direction to form a multi-pole magnet.

The second structural magnet 240 of the second connector 200 may include: a plurality of first polar magnets 241 and a plurality of second polar magnets 243, which are alternately arranged to be laterally adjacent to each other in the first direction based on the cross section to form a multi-pole magnet; and a plurality of first polar magnets 241 and a plurality of second polar magnets 243, which are provided to be also laterally attached in the third direction to form a multi-pole magnet.

Here, if the first polarity is an N pole, the second polarity may be an S pole, and conversely, if the first polarity is the S pole, the second polarity may be the N pole. In addition, the first direction may refer to the X-axis, the second direction may refer to the Y-axis, and the third direction may refer to the Z-axis.

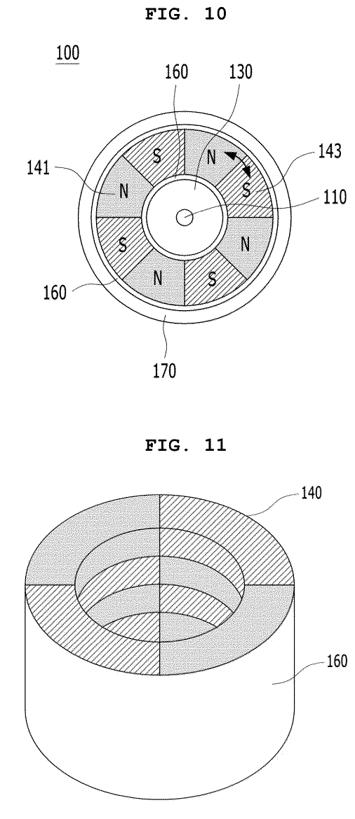

In the embodiment illustrated in FIG. 7, the case, in which four first polar magnets and four second polar magnets per connector are employed, has been described as an example, but the number of the magnets may not be limited thereto. For example, FIG. 10 shows a first connector provided with the greater number of magnets 141 and 143 in the first direction than the first connector 100 of the fourth embodiment shown in FIG. 7.

Referring to FIGS. 7 and 8, due to the above-described structure, when the portions where the first structural magnet 140 and the second structural magnet 240 face each other correspond to each other as magnets having different polarities, attraction is generated between the first structural magnet 140 and the second structural magnet 240 to cause the first connector 100 and the second connector 200 to be attached, such that the first signal conductor 110 and the second signal conductor 210 may be electrically contacted.

In one embodiment, the second structural magnet 240 may be inserted into a hole of the first structural magnet 140 formed in a donut shape, and the first connector 100 and the second connector 200 may be coupled and attached.

While the first connector 100 and the second connector 200 are attached, if an external force that twists the first connector 100 and the second connector 200 at a predetermined angle is generated from an outside, the portions where the first structural magnet 140 and the second structural magnet 240 face each other may be changed.

That is, the portions where the first structural magnet 140 and the second structural magnet 240 face each other may correspond to each other as magnets having the same polarity due to the external force that twists at least one of the first connector 100 and the second connector 200. Thereby, repulsion is generated between the first structural magnet 140 and the second structural magnet 240, such that the first connector 100 and the second connector 200 may be easily separated by the force pushing each other.

Accordingly, the electrical connection between the first signal conductor 110 and the second signal conductor 210 may be disconnected.

In the RF connector having a shielding structure according to an embodiment of the present invention, the force with which the first connector 100 and the second connector 200 are coupled may also be affected by the shielding structure which closely covers the magnets.

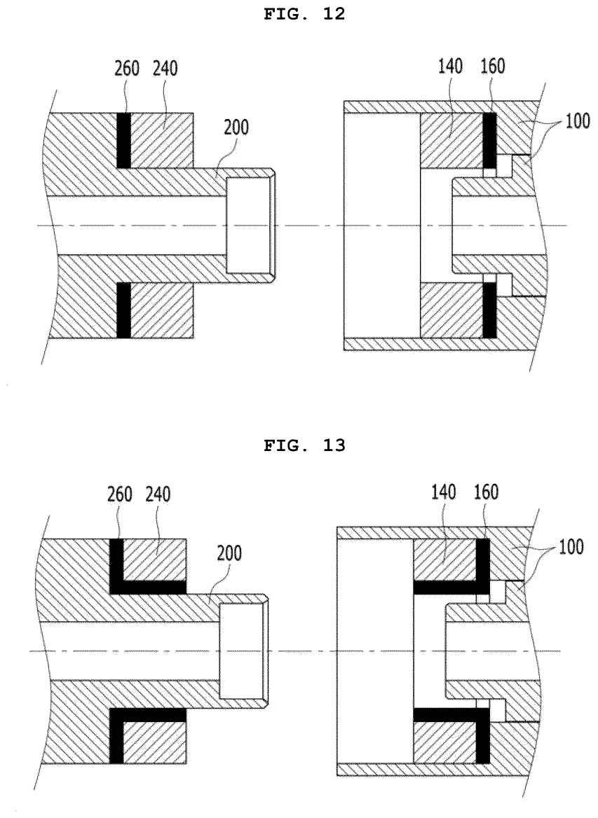

Specifically, as shown in FIG. 11, when a shielding structure 160 is provided on at least one surface other than the surface to which the first structural magnet 140 and the second structural magnet 240 are attached, the magnetic force is greater than the case of having no shielding structure.

For example, in the case where the number and structure of magnets mounted on the RF connectors having a shielding structure are the same, when experimentally measuring attractions generated between the first connector 100 and the second connector 200 on whether or not the shielding structure is provided around the outer circumference of each connector, it can be seen that the magnetic force generated between the magnets facing each other is greater in the case where the shielding structure is provided around the outer circumference of the RF connector than the case of having no shielding structure.

According to the above-described embodiment of the present invention, the designer of the RF connector may adjust the degree of cover of the shielding structure that covers the magnets depending on the type or use of the communication equipment on which the RF connector is to be mounted, thereby, when including the RF connector, it is possible to implement an RF connector with an appropriate coupling force depending on the purpose.

That is, based on the magnetism between the first connector and the second connector, which is determined by the degree of cover of the shielding structure that closely covers the magnets provided in the attachment and detachment portion between the RF connectors, an RF connector that implements a predetermined range of coupling force may be produced.

The shielding structure according to an embodiment of the present invention may closely cover at least one of a bottom surface, an inner peripheral surface, and an outer peripheral surface of at least one of the first structural magnet and the second structural magnet.

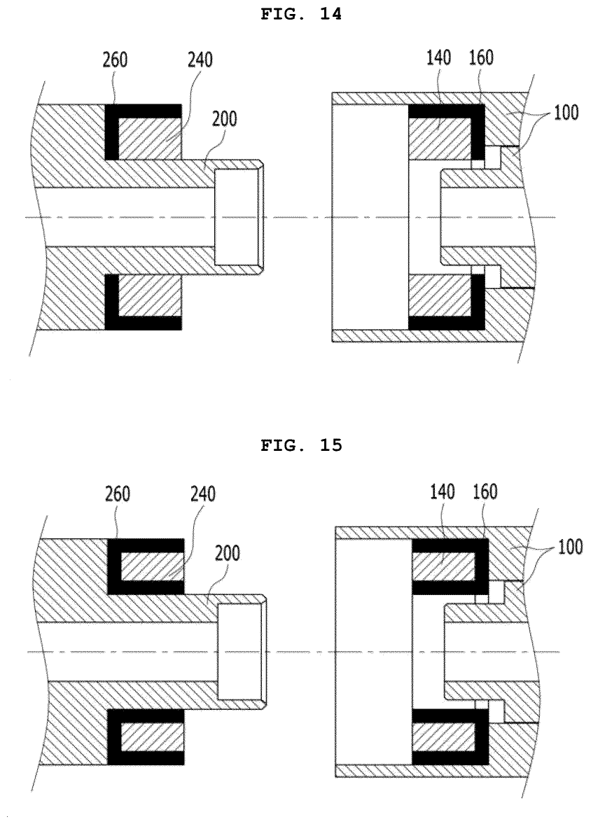

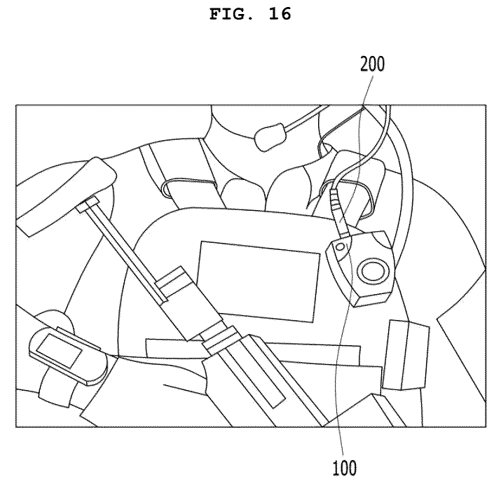

FIG. 12 is a longitudinal sectional view showing an RF connector having a shielding structure in which the shielding structure closely covers only each bottom surface of the magnets 140 and 240, FIG. 13 is a longitudinal sectional view showing an RF connector having a shielding structure in which the shielding structure closely covers each bottom surface and inner peripheral surface of the magnets 140 and 240, FIG. 14 is a longitudinal sectional view showing an RF connector having a shielding structure in which the shielding structure closely covers each bottom surface and outer peripheral surface of the magnets 140 and 240, and FIG. 15 is a longitudinal sectional view showing an RF connector having a shielding structure in which the shielding structure closely covers each bottom surface, inner peripheral surface and outer peripheral surface of the magnets 140 and 240.

Here, the material of the shielding structure is not particularly limited as long as it is commonly used in the art. For example, a magnetic material having high magnetic permeability, specifically, a magnetic material that can shield and reflect the magnetic force lines of the magnet while having high magnetic permeability may be used.

Specifically, the magnetic shielding member includes steel sheets such as carbon steel sheets (e.g., S45C, etc.), stainless steel sheets (e.g., SUS430, SUS304, etc.), free-cutting steel sheets (e.g., SUM21, SUM22, etc.), cold rolled steel sheets (SPCC), hot rolled carbon steel sheets, silicon steel sheets and the like. In addition, galvanized steel sheets obtained by electrolytic plating or electroless plating with (semi-) metals such as nickel, zinc and copper or an alloy thereof may also be used as the magnetic shielding member. Examples of these galvanized steel sheets include cold-rolled galvanized steel sheets, hot-rolled galvanized steel sheets, electrolytic galvanized iron (EGI), Galvanium-coated steel sheets (zinc aluminum alloy coated steel sheets), hot-dip galvanized steel sheets, electrolytic nickel-coated steel sheets, electroless nickel-coated steel sheets, copper-coated steel sheets and the like. The plating layer of the galvanized steel sheet may be a single layer or multiple layers.

In addition, the shielding structure may be subjected to surface treatment. Examples of the surface treatment method include chemical treatment such as chromate treatment, phosphate coating treatment (e.g., triphosphate coating treatment), phosphate chromate treatment, etc.; roughening treatment, and the like, but it is not limited thereto. The treatment has an shielding part subjected to surface increased adhesive force with a thermal fusion adhesive layer due to an increase in the surface energy.

For example, the magnetic shielding member may be one selected from the group consisting of nickel-coated steel sheet, electrolytic nickel-coated steel sheet, and electroless nickel-coated steel sheet, and in this case, the surface of the steel sheet may be subjected to chromate treatment. In this case, not only the adhesive force with the thermal fusion adhesive layer may be increased, but also the corrosion resistance may be enhanced.

Additionally, the thickness of the shielding structure is not particularly limited.

The shielding structure(s) may be disposed only on the bottom surfaces or top surfaces of the first structural magnet and the second structural magnet, disposed only on the side surfaces of the first structural magnet and the second structural magnet, or disposed on both the side surfaces and bottom surfaces of the first structural magnet and the second structural magnet.

By appropriately disposing the shielding parts on the outermost surfaces of the first structural magnet and the second structural magnet, the magnetic field around the magnet may be blocked, and in some cases, the magnitude of the magnetic force may be further maximized.

Meanwhile, according to the RF connector having a shielding structure according to an embodiment of the present invention, when an abnormality occurs in the attachment or detachment functions of the first connector or the second connector, a product is defective, or it is intended to change the coupling force, only the magnet portions of the first structural magnet and the second structural magnet may be removed and replaced. That is, without having to replace the entire RF cable, it is possible to overcome defects in the attachment and detachment functions or change the coupling force between the connectors by removing only the magnet portions of the first structural magnet and the second structural magnet and replacing them with new ones. Here, the method of removing and reinserting the magnet from each connector may use known technologies, therefore will not be described in detail.

At this time, it is also possible to make a change in the shielding structure that closely covers at least one surface of the magnet. For example, conventionally, the shielding structure was provided only on the bottom surface of the first structural magnet and the second structural magnet in the art, but in order to increase the shielding function of the RF connector in the present invention, it may also have a shielding structure that closely covers the entire surface other than the surface to which the first structural magnet and the second structural magnet are attached through replacement.

FIG. 16 shows an example of utilization of the RF connector having a shielding structure according to embodiments of the present invention.

According to the RF connector having a shielding structure according to an embodiment of the present invention, in an environment such as war, when soldiers who use communication equipment should replace and change the communication equipment in an urgent situation, it is possible to easily and quickly perform the attachment and detachment of the RF connector having a shielding structure.

In addition, although not shown in the drawings, it is possible to easily inspect or replace cables that occur in the future for communication cables constructed in the apartments or buildings, as well as the cable of the problem can be solved in units of the RF connector of the present invention without replacing the entire cable, thereby it is possible to economically reduce costs.

As described above, optimal embodiments have been disclosed in the drawings and the specification. Although specific terms have been used herein, these are only intended to describe the present invention and are not intended to limit the meanings of the terms or to restrict the scope of the present invention as disclosed in the accompanying claims. Accordingly, those skilled in the art will appreciate that various modifications and other equivalent embodiments are possible from the above embodiments. Therefore, the scope of the present invention should be defined by the technical spirit of the accompanying claims.

The present invention may be applied to the RF connector having a shielding structure which may be implemented to have a coupling force that meets a purpose depending on the type or use of communication facility and equipment on which the RF connector is to be mounted, and has a shielding function while allowing for easy attachment and detachment thereof.

1. A radio frequency (RF) connector comprising:
a first connector comprising a first magnet having a first structure at a portion of an end thereof;
a second connector comprising a second magnet having a second structure at a portion of an end thereof, wherein a polarity of a portion of the second magnet facing the first magnet is opposite to a polarity of the first magnet, and the end of the second connector is detachably attached to the end of the first connector by a magnetic force generated between the first magnet and the second magnet; and
a shielding structure provided on at least one surface other than a surface where the first magnet and the second magnet are attached to each other.

2. The RF connector according to claim 1, wherein the first connector comprises:
a first signal conductor disposed to penetrate a cross section of the end of the first connector in a longitudinal direction of the first connector;
an insulation part disposed to surround the first signal conductor; and
the first magnet provided along a portion of the insulation part.

3. The RF connector according to claim 2, wherein the second connector comprises:
a second signal conductor disposed to penetrate a cross section of the end of the second signal conductor in a longitudinal direction of the second connector;
an insulation part disposed to surround the second signal conductor; and
the second magnet provided along a portion of the insulation part.

4. The RF connector according to claim 3, wherein, when the first magnet and the second magnet are attached by attraction, the first signal conductor and the second signal conductor come into close contact with each other to be electrically contacted.

5. The RF connector according to claim 3, wherein the first structure is provided as a first polar magnet over an entire cross section, and the second structure of the second magnet is provided as a second polar magnet having a polarity opposite to a polarity of the first polar magnet over an entire cross section.

6. The RF connector according to claim 3, wherein the first structure of the first magnet comprises a first polar magnet and a second polar magnet having a polarity opposite to the first polarity, which are provided laterally adjacent to each other based on the cross section, and
the second structure of the second magnet comprises a first polar magnet and a second polar magnet having a polarity opposite to the first polarity, which are provided laterally adjacent to each other based on the cross section.

7. The RF connector according to claim 6, wherein the first structure of the first magnet comprises a plurality of first polar magnets and a plurality of second polar magnets, which are alternately arranged to be laterally adjacent in the first direction based on the cross section to form a multi-pole magnet, and
the second structure of the second magnet comprises a plurality of first polar magnets and a plurality of second polar magnets, which are alternately arranged to be laterally adjacent in the first direction based on the cross section to form a multi-pole magnet.

8. The RF connector according to claim 7, wherein the first structure of the first magnet comprises a plurality of first polar magnets and a plurality of second polar magnets, which are alternately arranged in at least one of the first direction, a second direction and a third direction based on the cross section to form a multi-pole magnet, and
the second structure of the second magnet comprises a plurality of first polar magnets and a plurality of second polar magnets, which are alternately arranged in at least one of the first direction, the second direction and the third direction based on the cross section to form a multi-pole magnet,
wherein the first direction is an X-axis direction, the second direction is a Y-axis direction, and the third direction is a Z-axis direction.

9. The RF connector according to claim 6, wherein the first connector and the second connector have structures configured to, while portions where the first magnet and the second magnet face each are attached by the attraction, to be separated by repulsion generated as the portions facing each other are changed due to an external force applied from an outside.

10. The RF connector according to claim 1, wherein the shielding structure is made of any one material or two or more materials of carbon fiber, carbon nanotube (CNT), carbon black, graphene, aluminum, titanium, zinc, iron, nickel, chromium, cobalt, copper, silver and gold.

11. The RF connector according to claim 1, wherein the shielding structure closely covers at least one of a bottom surface, an inner peripheral surface, and an outer peripheral surface of at least one of the first magnet and the second magnet.
